(19) United States
(12) Patent Application Publication
(10) Pub. No.: US 2015/0244063 A1
(43) Pub. Date: Aug. 27, 2015

(54) APPARATUS FOR WIRELESS COMMUNICATION

(71) Applicant: Nokia Technologies Oy, Espoo (FI)

(72) Inventor: Arun Sowpati, Espoo (FI)

(21) Appl. No.: 14/628,530

(22) Filed: Feb. 23, 2015

(30) Foreign Application Priority Data
Feb. 24, 2014 (GB) 1403144.7

(51) Int. Cl. H01Q 1/24

(52) U.S. Cl. CPC H01Q 1/243

(57) ABSTRACT

An apparatus comprising: a ground member; a conductive cover portion defining a first non-conductive aperture and grounded to the ground member; and an antenna configured to couple to radio frequency circuitry, the antenna being positioned at least in part within the periphery of the first non-conductive aperture.

### TECHNOLOGICAL FIELD

Embodiments of the present invention relate to an apparatus for wireless communication. In particular, they relate to an apparatus for wireless communication in portable electronic devices.

### BACKGROUND

Apparatus, such as portable electronic devices, usually include an antenna arrangement to enable the apparatus to communicate wirelessly with other such devices. The apparatus usually also includes a cover to house the circuitry of the apparatus and the antenna arrangement. Recently, there has been a trend for covers of portable electronic devices to include a metal such as aluminium. Metal covers are advantageous in that they may provide a robust housing which is aesthetically attractive to users.

### BRIEF SUMMARY

According to various, but not necessarily all, embodiments of the invention there is provided an apparatus comprising: a ground member; a conductive cover portion defining a first non-conductive aperture and grounded to the ground member; and an antenna configured to couple to radio frequency circuitry, the antenna being positioned at least in part within the periphery of the first non-conductive aperture.

The first non-conductive aperture may be configured to enable a non-antenna related function in addition to having at least a part of the antenna positioned therein.

The first non-conductive aperture may be configured to receive at least a part of a camera module therein.

The first non-conductive aperture may be configured to receive a dielectric member therein adjacent the camera module.

The antenna may define a second non-conductive aperture configured to receive at least a part of a camera module therein.

The antenna may provide a cover portion of the apparatus.

The antenna may have a first end and a second end, the antenna may be coupled to a feed point between the first end and the second end, and grounded at the second end.

The first end of the antenna may be electrically open.

The conductive cover portion may comprise a ground point. The antenna may be coupled to the ground point.

The conductive cover portion may comprise a feed point configured to couple to the radio frequency circuitry, the antenna may be coupled to the feed point.

The apparatus may further comprise one or more further antennas having a stacked arrangement with the antenna. The one or more further antennas may be positioned at least in part within the periphery of the first non-conductive aperture.

The apparatus may further comprise a camera module. The antenna may be unattached to the camera module.

According to various, but not necessarily all, embodiments of the invention there is provided a portable electronic device comprising an apparatus as described in any of the preceding paragraphs.

According to various, but not necessarily all, embodiments of the invention there is provided a method comprising: providing a ground member; providing a conductive cover portion defining a first non-conductive aperture and grounded to the ground member; and providing an antenna configured to couple to radio frequency circuitry, the antenna being positioned at least in part within the periphery of the first non-conductive aperture.

The block of providing an antenna may include providing a plurality of antennas in a stacked arrangement.

The first non-conductive aperture may be configured to enable a non-antenna related function in addition to having at least a part of the antenna positioned therein.

The first non-conductive aperture may be configured to receive at least a part of a camera module therein.

The antenna may define a second non-conductive aperture configured to receive at least a part of a camera module therein.

The antenna may provide a cover portion of the apparatus.

The antenna may have a first end and a second end. The antenna may be coupled to a feed point between the first end and the second end, and grounded at the second end.

The first end of the antenna may be electrically open.

The conductive cover portion may comprise a ground point. The antenna may be coupled to the ground point.

The conductive cover portion may comprise a feed point configured to couple to the radio frequency circuitry. The antenna may be coupled to the feed point.

The method may further comprise providing a camera module, the antenna being unattached to the camera module.

### BRIEF DESCRIPTION

For a better understanding of various examples that are useful for understanding the brief description, reference will now be made by way of example only to the accompanying drawings in which:

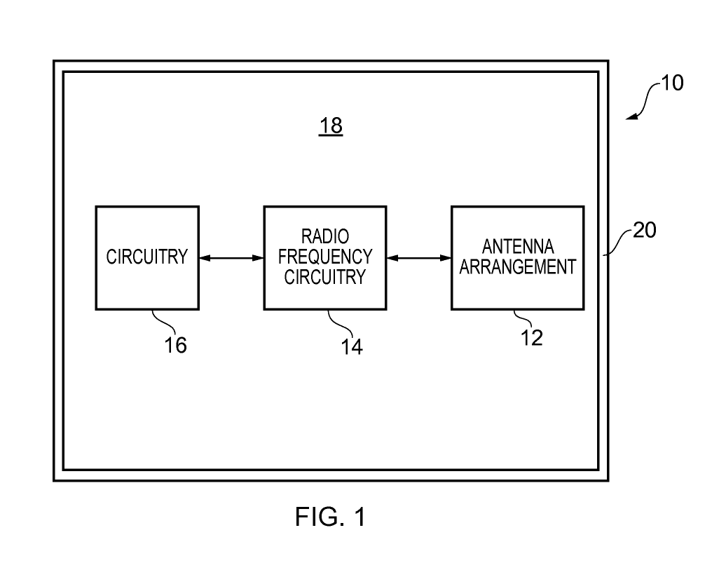

FIG. 1 illustrates a schematic diagram of a portable electronic device according to various examples;

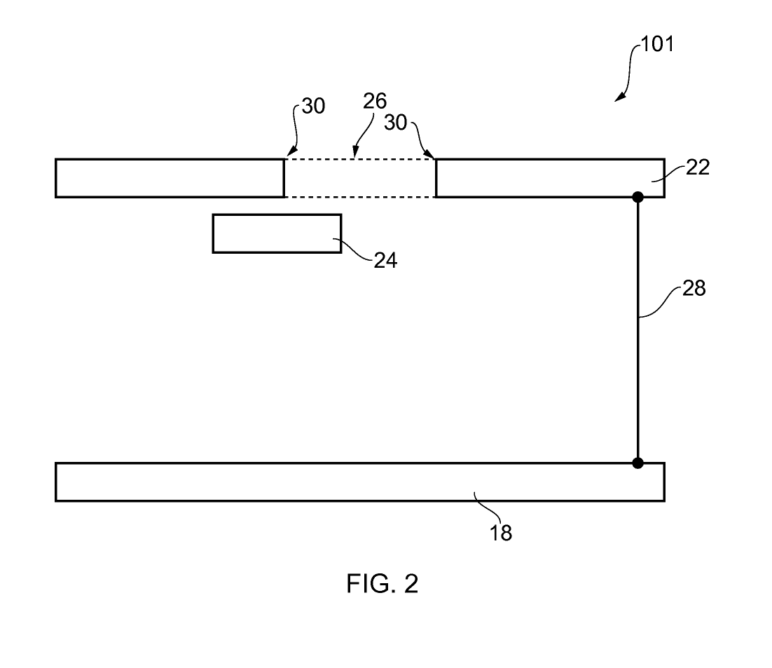

FIG. 2 illustrates a schematic side view of an apparatus according to various examples;

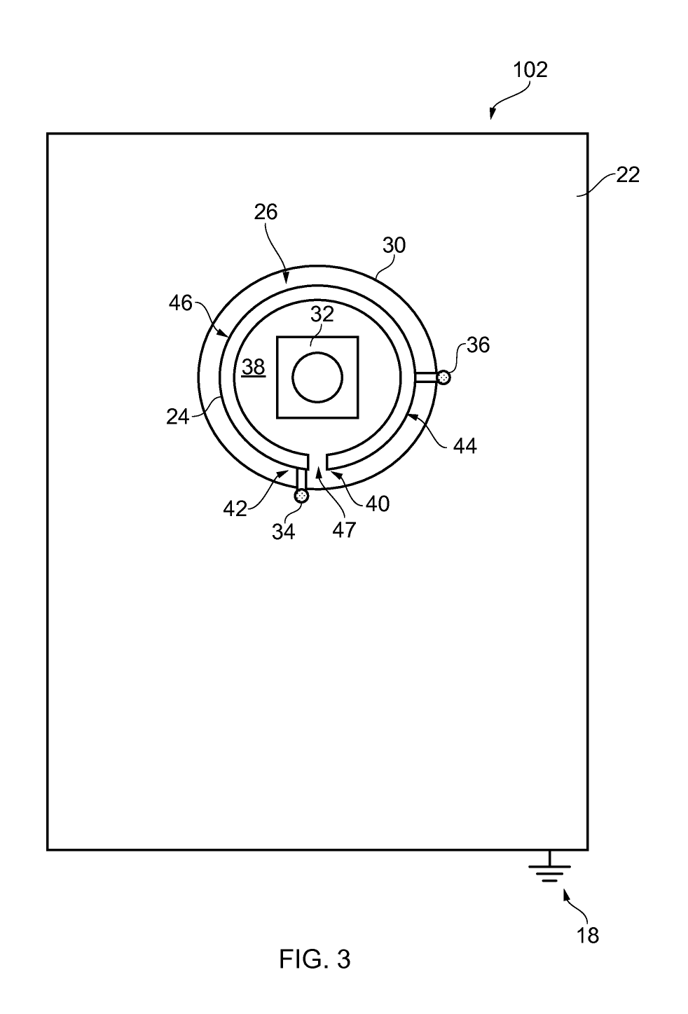

FIG. 3 illustrates a plan view of another apparatus according to various examples;

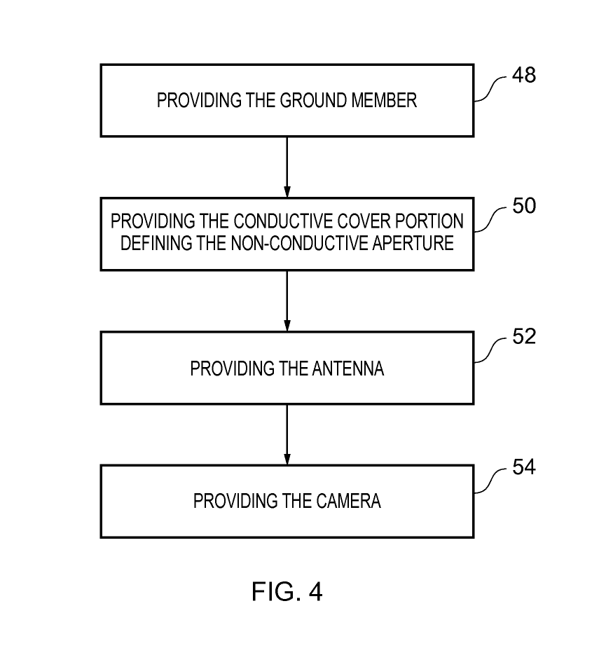

FIG. 4 illustrates a flow diagram of a method according to various examples; and

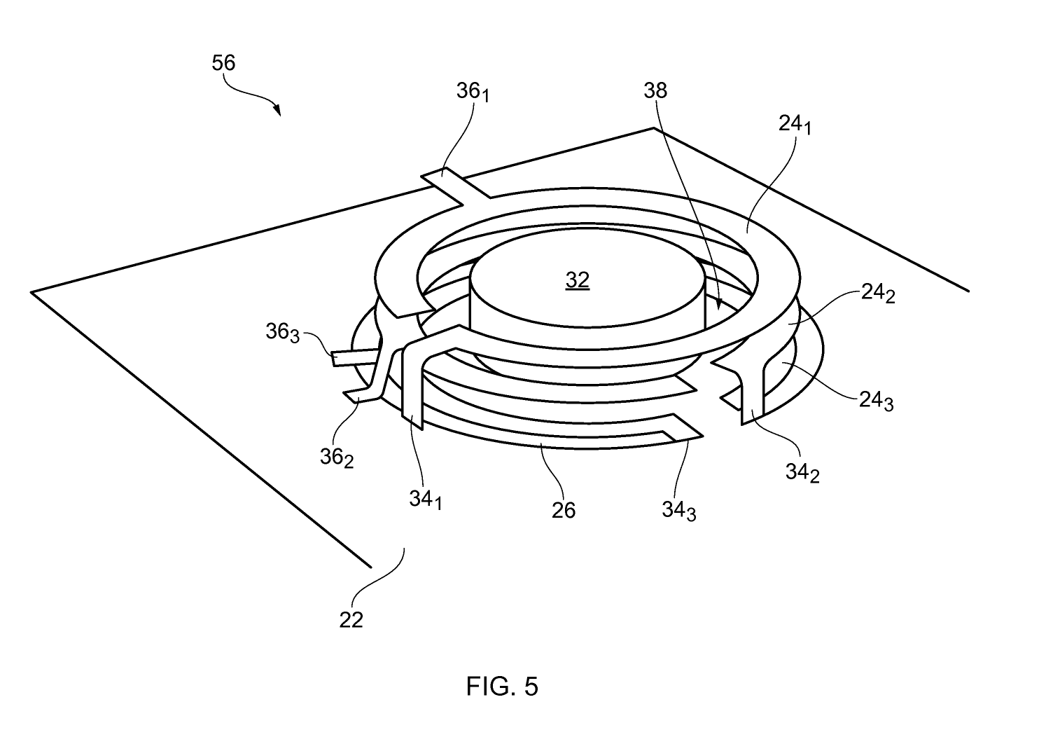

FIG. 5 illustrates a schematic side view of a further apparatus according to various examples.

### DETAILED DESCRIPTION

In the following description, the wording ‘connect’ and ‘couple’ and their derivatives mean operationally connected or coupled. It should be appreciated that any number or combination of intervening components can exist (including no intervening components). Additionally, it should be appreciated that the connection or coupling may be a physical galvanic connection and/or an electromagnetic connection.

FIG. 1 illustrates an electronic device 10 which may be any apparatus such as a hand portable electronic device (for example, a mobile cellular telephone, a tablet computer, a laptop computer, a personal digital assistant or a hand held computer), a non-portable electronic device (for example, a personal computer or a base station for a cellular network), a portable multimedia device (for example, a music player, a video player, a game console and so on) or a module for such devices. As used here, the term ‘module’ refers to a unit or apparatus that excludes certain parts or components that would be added by an end manufacturer or a user.

The electronic device 10 comprises an antenna arrangement 12, radio frequency circuitry 14, circuitry 16, a ground member 18, and a cover 20. Where the electronic device 10 is a module, the electronic device 10 may only include the antenna arrangement 12, the cover 20 and the ground member 18.

The antenna arrangement 12 includes at least one radiator, but may in other examples include a plurality of radiators that are configured to transmit and receive, transmit only or receive only electromagnetic signals. The radio frequency circuitry 14 is connected between the antenna arrangement 12 and the circuitry 16 and may include a receiver and/or a transmitter and/or a transceiver. The circuitry 16 is operable to provide signals to, and/or receive signals from the radio frequency circuitry 14. The electronic device 10 may optionally include one or more matching circuits, filters, switches, or other radio frequency circuit elements, and combinations thereof, between the antenna arrangement 12 and the radio frequency circuitry 14.

The radio frequency circuitry 14 and the antenna arrangement 12 may be configured to operate in a plurality of operational frequency bands. For example, the operational frequency bands may include (but are not limited to) Long Term Evolution (LTE) (B17 (DL:734-746 MHz; UL:704-716 MHz), B5 (DL:869-894 MHz; UL: 824-849 MHz), B20 (DL: 791-821 MHz; UL: 832-862 MHz), B8 (925-960 MHz; UL: 880-915 MHz), B13 (DL: 746-756 MHz; UL: 777-787 MHz), B28 (DL: 758-803 MHz; UL: 703-748 MHz), B7 (DL: 2620-2690 MHz; UL: 2500-2570 MHz), B38 (2570-2620 MHz), B40 (2300-2400 MHz) and B41 (2496-2690 MHz)), amplitude modulation (AM) radio (0.535-1.705 MHz); frequency modulation (FM) radio (76-108 MHz); Bluetooth (2400-2483.5 MHz, 5 GHz); wireless local area network (WLAN) (2400-2483.5 MHz); hiper local area network (HiperLAN) (5150-5850 MHz); global positioning system (GPS) (1570.42-1580.42 MHz); US-Global system for mobile communications (US-GSM) 850 (824-894 MHz) and 1900 (1850-1990 MHz); European global system for mobile communications (EGSM) 900 (880-960 MHz) and 1800 (1710-1880 MHz); European wideband code division multiple access (EU-WCDMA) 900 (880-960 MHz); personal communications network (PCN/DCS) 1800 (1710-1880 MHz); US wideband code division multiple access (US-WCDMA) 1700 (transmit: 1710 to 1755 MHz, receive: 2110 to 2155 MHz) and 1900 (1850-1990 MHz); wideband code division multiple access (WCDMA) 2100 (transmit: 1920-1980 MHz, receive: 2110-2180 MHz); personal communications service (PCS) 1900 (1850-1990 MHz); time division synchronous code division multiple access (TD-SCDMA) (1900 MHz to 1920 MHz, 2010 MHz to 2025 MHz), ultra wideband (UWB) Lower (3100-4900 MHz); UWB Upper (6000-10600 MHz); digital video broadcasting-handheld (DVB-H) (470-702 MHz); DVB-H US (1670-1675 MHz); digital radio mondiale (DRM) (0.15-30 MHz); worldwide interoperability for microwave access (WiMax) (2300-2400 MHz, 2305-2360 MHz, 2496-2690 MHz, 3300-3400 MHz, 3400-3800 MHz, 5250-5875 MHz); digital audio broadcasting (DAB) (174.928-239.2 MHz, 1452.96-1490.62 MHz); radio frequency identification low frequency (RFID LF) (0.125-0.134 MHz); radio frequency identification high frequency (RFID HF) (13.56-13.56 MHz); radio frequency identification ultra high frequency (RFID UHF) (433 MHz, 865-956 MHz, 2450 MHz), inductive power standard (Qi) frequencies.

A frequency band over which an antenna can efficiently operate is a frequency range where the antenna's return loss is less than an operational threshold. For example, efficient operation may occur when the antenna's return loss is better than (that is, less than) −4 dB or −6 dB.

The antenna arrangement 12 may comprise, and is not limited to, one or more of a loop antenna, a monopole antenna, a dipole antenna, a PIFA (Planar Inverted-F Antenna), an IFA (Inverted-F Antenna), an ILA (Inverted-L Antenna), a coil or helical antenna and a patch antenna. Where the antenna arrangement 12 includes two or more antennas, the antenna arrangement 12 may provide a part of a diversity arrangement (for example, a first antenna of two or more), a diversity antenna arrangement on its own, a part of a multiple input multiple output (MIMO) arrangement (for example, a first antenna of two or more), or a multiple input multiple output (MIMO) arrangement.

The circuitry 16 may include processing circuitry, memory circuitry and input/output devices such as an audio input device (a microphone for example), an audio output device (a loudspeaker for example), a display, a camera, charging circuitry, and a user input device (such as a touch screen display and/or one or more buttons or keys).

The antenna arrangement 12 and the electronic components that provide the radio frequency circuitry 14 and the circuitry 16 may be interconnected via the ground member 18 (for example, a printed wiring board). The ground member 18 may be used as a ground plane for the antenna arrangement 12 by using one or more layers of the printed wiring board. In other embodiments, some other conductive part of the electronic device 10 (a battery cover or a chassis (such as a display chassis) within the interior of the cover 20 for example) may be used as the ground member 18 for the antenna arrangement 12. In some examples, the ground member 18 may be formed from several conductive parts of the electronic device 10, one part of which may include the printed wiring board. The ground member 18 may be planar or non-planar.

The cover 20 has an exterior surface that defines one or more exterior visible surfaces of the electronic device 10 and also has an interior surface that defines a cavity configured to house the electronic components of the electronic device 10 such as the radio frequency circuitry 14, the circuitry 16 and the ground member 18. The cover 20 may comprise a plurality of separate cover portions that may be coupled to one another to form the cover 20. For example, the cover 20 may include a front cover portion that is provided by a display module, and a back cover portion that couples to the display module.

FIG. 2 illustrates a schematic side view of an apparatus 101 according to various examples. The apparatus 101 is similar to the apparatus 10 illustrated in FIG. 1 and where the features are similar, the same reference numerals are used. The apparatus 101 includes a ground member 18, a conductive cover portion 22, and an antenna 24.

The conductive cover portion 22 may comprise any suitable conductive material and may comprise a metal and/or a conductive polymer. The conductive cover portion 22 is at least a part of the cover 20 and may be a rear part of the cover 20. In other words, the conductive cover portion 22 may be the part of the cover 20 that is configured to be positioned opposite a display of the apparatus 101. The conductive cover portion 22 defines a first non-conductive aperture 26 and is grounded to the ground member 18 via at least a ground connection 28.

The first non-conductive aperture 26 extends through the conductive cover portion 22 and may have any shape defined by the periphery 30 of the first non-conductive aperture 26. The periphery 30 of the first non-conductive aperture 26 is the part of the conductive cover portion 22 that defines the first non-conductive aperture 26 and may also be referred to as a ‘peripheral edge’ or a ‘peripheral wall’ of the first non-conductive aperture 26. In some examples, the first non-conductive aperture 26 may be circular. In other examples, the first non-conductive aperture 26 may have an elliptical shape, a rectangular shape, a square shape, or any other regular shape, or alternatively any irregular shape, for example. The first non-conductive aperture 26 may have any suitable dimensions and in some examples where the first non-conductive aperture 26 is circular, the first non-conductive aperture 26 may have a diameter of 40 mm or more.

The antenna 24 is configured to couple to the radio frequency circuitry 14. For example, the antenna 24 may include a connector that is configured to connect to the radio frequency circuitry 14. In other examples, the antenna 24 may not include a connector and the apparatus 101 may instead include a connector for connecting the antenna 24 to the radio frequency circuitry 14. In some examples, the antenna 24 may be connected to the radio frequency circuitry 14 via a connector mounted on the conductive cover portion 22. In other examples, the antenna 24 may be connected to the radio frequency circuitry 14 via a connector mounted on another component of the apparatus 101, or via a connector that extends directly between the radio frequency circuitry 14 and the antenna 24, for example a connector may be soldered at a first end to the printed wiring board and a second end of the connector extend towards the antenna in order to make contact with the antenna 24. In some examples, the antenna 24 is grounded via a connection to the conductive cover portion 22. In other examples, the antenna 24 may be grounded via a connection to another component of the apparatus 101. In further examples, the antenna 24 may be grounded via a direct connection to the ground member 18.

The antenna 24 is positioned at least in part within the periphery 30 of the first non-conductive aperture 26. In other words, when the apparatus 101 is viewed in plan, the area of the antenna 24 at least partially overlaps with the area of the first non-conductive aperture 26. In some examples, the antenna 24 may be positioned wholly within the periphery 30 of the first non-conductive aperture 26.

The antenna 24 may be positioned within the first non-conductive aperture 26 such that the antenna 24 is in the same plane as the conductive cover portion 22. Consequently, the antenna 24 may provide a cover portion of the apparatus 101 (that is, the cover 20 may comprise the antenna 24) as the same material used to make the cover is used to provide the antenna 24. In other examples, the antenna 24 may be positioned in a different plane to the conductive cover portion 22 and may therefore not be positioned within the first non-conductive aperture 26. In these examples, the antenna 24 may not provide a cover portion of the apparatus 101 (that is, the cover 20 may not comprise the antenna 24) and the antenna 24 may be made from a different material than that of the cover portion 22.

The first non-conductive aperture 26 may be configured to enable a non-antenna related function in addition to having at least a part of the antenna 24 positioned within the periphery 30. In more detail, the first non-conductive aperture 26 may be shaped and sized to enable an electronic component of the apparatus 101 to perform a function.

For example, the first non-conductive aperture 26 may be configured to receive at least a part of a camera module therein, or alternatively configured to locate at least a part of a camera module in close proximity to the non-conductive aperture 26, and consequently, the first non-conductive aperture 26 may be configured to enable the camera module to capture an image. In this example, light is able to pass through the non-conductive aperture 26 to the camera module. In some example, the first non-conductive aperture 26 may be configured to receive a dielectric member therein adjacent the camera module.

By way of another example, the first non-conductive aperture 26 may be configured to receive at least a part of a loudspeaker therein, or alternatively configured to locate at least a part of a loudspeaker in close proximity to the non-conductive aperture 26, and consequently, the first non-conductive aperture 26 may be configured to enable the loudspeaker to project acoustic waves from the apparatus 101. In this example, acoustic waves are able to pass through the non-conductive aperture 26 from the loudspeaker.

By way of a further example, the first non-conductive aperture 26 may be configured to receive at least a part of a microphone therein, and consequently, the first non-conductive aperture 26 may be configured to enable the microphone to receive acoustic waves.

FIG. 3 illustrates a plan view of another apparatus 102 according to various examples. The apparatus 102 is similar to the apparatus 10 and the apparatus 101 illustrated in FIGS. 1 and 2 respectively, and where the features are similar, the same reference numerals are used. The apparatus 102 comprises a conductive cover portion 22, an antenna 24, a ground member 18 and a camera module 32.

The first non-conductive aperture 26 is circular and the antenna 24 is positioned wholly within the first non-conductive aperture 26. The antenna 24 is also positioned within the same plane as the conductive cover portion 22 (that is, the antenna 24 and the conductive cover portion 22 are co-planar). The conductive cover portion 22 comprises a ground point 34 and the antenna 24 is coupled to the ground point 34 (for example, via a galvanic connection). The conductive cover portion 22 also comprises a feed point 36 that is configured to couple to the radio frequency circuitry 14 (for example, via a galvanic connection). The antenna 24 is coupled to the feed point 36 (for example, via a galvanic connection such as spring clips or pogo pin or feeding from PWB).

The conductive cover portion 22 may comprise mechanical and electrical transmission line structures (for example, a coaxial cable, stripline, or a microstrip) or alternative antenna feed structures (for example, pogo pins or spring clips) to provide the bridge between the antenna feed point 36 and the radio frequency circuitry 14 (for example, an input/output pin of a transistor or other semiconductor device acting as a power amplifier (Transmit chain) or low noise amplifier (LNA, in the Receive chain)). In alternative embodiments, the radio frequency feed can be provided directly between the radio frequency circuitry 14 and the antenna 24. When the cover 20 is used to provide the feed, the cover being a relatively large item, may advantageously provide substantial mechanical support for the feed structure. Also, the radio frequency feed may be electrically isolated from the cover 20 (since the cover is grounded), but a grounded part of the feed, for example, the outer conductive surface of a coaxial cable, may be grounded to the cover, whereas the inner conductor of the coaxial cable may provide the radio frequency feed and be electrically isolated from the cover. A conductive “launch pad” which is configured to be electrically isolated from the cover 20 may be provided on the underside of the cover 20 to provide the radio frequency feed to the antenna 24.

The antenna 24 has a ring shape and defines a second non-conductive aperture 38 therein. The second non-conductive aperture 38 is circular in this example, but may have any other shape in other examples. The curvature of the antenna 24 may correspond to the curvature of the periphery 30 of the first non-conductive aperture 26. This may result in a constant distance between the antenna 24 and the periphery 30 of the first non-conductive aperture 26 which may improve the radio frequency performance of the antenna 24. In other examples, the outline of the antenna 24 may not follow the outline of the first non-conductive aperture 26 and one or more portions of the antenna 24 may be closer or further away, to the outline of the first non-conductive aperture 26, than one or more other portions of the antenna 24. This may result in increased capacitance and/or inductance for one or more resonant frequencies of the antenna 24 dependent on which portion of the antenna 24 is closer or further away from the first non-conductive aperture 26. As one non-limiting example this may result in the antenna 24 having a physical size which is smaller (whilst maintaining the electrical size of the antenna 24) than for an antenna 24 which does not have one or more portions arranged close to the first non-conductive aperture 26.

The second non-conductive aperture 38 is configured to receive at least a part of the camera module 32 therein or at least in close proximity to the aperture. In other words, the antenna 24 is sized and shaped such that the second non-conductive aperture 38 may receive at least a part of the camera module 32 therein. It should be appreciated that in other examples, the antenna 24 may be sized and shaped such that the second non-conductive aperture 38 may receive at least a part of another component (such as a loudspeaker or a microphone) of the apparatus 102 therein. In some examples, any or all of the camera, loudspeaker and microphone may be located in proximity to the first aperture 26 and the second aperture 38.

The antenna 24 may be unattached to the camera module 32. In more detail, neither the antenna 24, nor the camera module 32, are adapted, or include any mechanism, for connecting the antenna 24 to the camera module 32. Furthermore, the antenna 24 and the camera module 32 are spaced apart from one another, and do not abut one another. There may be no electrical connection between the antenna 24 and the camera module 32. In some examples, there may be a ground connection only between the antenna 24 and the camera module 32 (for example, an outside chassis of the camera module 32 may be grounded). The grounding of the camera module 32 chassis is a baseband type ground and does not include a connection to the radio frequency circuitry 14 or the antenna 24.

The antenna 24 has a first end 40 and a second (opposite) end 42. The antenna 24 is coupled to the feed point 36 between the first end 40 and the second end 42. The antenna 24 is connected to the ground point 34 at the second end 42 and is electrically open at the first end 40. Consequently, the antenna 24 includes a first antenna 44 extending from the feed point 36 to the first end 40 (a monopole antenna in this example), and a second antenna 46 extending from the feed point 36 to the second end 42 (a loop antenna in this example).

The first end 40 and the second end 42 are separated by a gap 47 there between. The gap 47 has a physical dimension which may enable the antenna 24 to work with optimal radiated efficiency and impedance bandwidth. For example, if the gap 47 is too small, the first end 40 will electromagnetically couple heavily with the second end 42, which is grounded via ground point 34. If the gap dimension is large enough at the resonant frequency of interest, then the first end 40 will not significantly electromagnetically couple with the second end 42 and consequently the monopole or first antenna will radiate efficiently and have the required impedance bandwidth, and similarly the loop or second antenna will not be affected in terms of resonance and/or impedance bandwidth.

The first antenna 44 and the second antenna 46 may have different physical lengths and may therefore also have different electrical lengths. Consequently, the first antenna 44 may be configured to operate in at least a first operational frequency band, and the second antenna 46 may be configured to operate in at least a second operational frequency band, different to the first operational frequency band. In one example, the first and second operational frequency bands include WLAN (2.4 GHz and 5 GHz) and GPS (1570.42-1580.42 MHz).

FIG. 4 illustrates a flow diagram of a method of manufacturing an apparatus 10, 101, 102 according to various examples. At block 48, the method includes providing the ground member 18. At block 50, the method includes providing the conductive cover portion 22 that defines the first non-conductive aperture 26. At block 52, the method includes providing the antenna 24. At block 54, the method includes providing the camera module 32.

The apparatus 10, 101, 102 may provide several advantages. For example, since the antenna 24 is provided at least partly within the first non-conductive aperture 26 instead of at the top of the apparatus 10, 101, 102 (that is, the part of the apparatus that usually includes the loudspeaker), the display of the apparatus 10, 101, 102 may be larger.

Additionally, the positioning of the antenna 24 may provide sufficient space for multiple input multiple output (MIMO) antennas to be located at the top of the apparatus 10, 101, 102. Consequently, the apparatus 10, 101, 102 may advantageously be operable in LTE operational frequency bands.

Furthermore, since the antenna 24 is provided at least partly within the first non-conductive aperture 26 instead of at the top of the apparatus 10, 101, 102, the cover 20 at the top of the apparatus 10, 101, 102 may include fewer (or no) non-conductive areas for enabling wireless communication from antennas within the apparatus. Consequently, the cover 20 of the apparatus 10, 101, 102 may appear more aesthetically pleasing to a user.

The blocks illustrated in FIG. 4 may represent steps in a method and/or sections of code in a computer program. For example, a controller may control machinery by executing the computer program to perform the method illustrated in FIG. 4. The illustration of a particular order to the blocks does not necessarily imply that there is a required or preferred order for the blocks and the order and arrangement of the block may be varied. Furthermore, it may be possible for some blocks to be omitted.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one” or by using “consisting”.

In this brief description, reference has been made to various examples. The description of features or functions in relation to an example indicates that those features or functions are present in that example. The use of the term ‘example’ or ‘for example’ or ‘may’ in the text denotes, whether explicitly stated or not, that such features or functions are present in at least the described example, whether described as an example or not, and that they can be, but are not necessarily, present in some or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class.

Although embodiments of the present invention have been described in the preceding paragraphs with reference to various examples, it should be appreciated that modifications to the examples given can be made without departing from the scope of the invention as claimed. For example, the antenna arrangement 12 may include a Near Field Communication (NFC) antenna (configured to operate at 13.56 MHz), which has a separate feed, and is positioned in the non-conductive aperture area 26 between the antenna 24 and the camera module 32.

In various examples, the antenna arrangement 12 may include a stacked arrangement 56 of antennas as illustrated in FIG. 5. The antennas in the stacked arrangement 56 may be provided by any suitable conductive element and may be provided by any combination of an antenna, a radiator, a parasitic element, a grounded element (for example, a portion of a ground plane).

The stacked arrangement 56 includes a first antenna 24₁, a second antenna 24₂ and a third antenna 24₃ that are stacked vertically relative to the conductive cover portion 22. In other words, the first, second and third antennas 24₁, 24₂, 24₃ at least partially overlay one another. The antennas 24₁, 24₂ and 24₃ are positioned at least in part within the periphery of the first non-conductive aperture 26.

The antennas 24₁, 24₂, 24₃ have the same structure as the antenna 24 illustrated in FIG. 3. In other examples, the antennas 24₁, 24₂, 24₃ may have a different structure. A camera module 32 is positioned within the second non-conductive apertures 38 defined by the antennas 24₁, 24₂, 24₃.

Each of the antennas 24₁, 24₂, 24₃ on each layer may be separate to the remaining antennas 24₁, 24₂, 24₃ in the stacked arrangement 56 and may be configured to resonate at a different operational frequency band. While the stacked arrangement 56 includes three antennas in this example, it should be appreciated that the stacked arrangement 56 of antennas may include two or more layers of antennas for example. Although in the example of FIG. 5 separate radio frequency grounds 34₁, 34₂, 34₃ have been illustrated, one for each antenna, in other examples a radio frequency ground, for example at least one of the grounds 34₁, 34₂, 34₃, may be shared between the antennas 24₁, 24₂, 24₃ but each antenna may have a different radio frequency feed.

In some examples, one or more of the antennas 24₁, 24₂, 24₃ may instead provide a parasitic radiating element. In these examples, the one or more radiators would only be grounded at one or more locations of the parasitic radiator and would not have a radio frequency feed directly coupled to the parasitic radiating element, but instead would electromagnetically couple to an adjacent radiator in the stacked arrangement where the adjacent radiator is coupled to a radio frequency feed.

One or more of the antennas 24₁, 24₂, 24₃ in the stacked arrangement 56 may use the aperture 26 to radiate without affecting the camera module 32 (or other electronic components such as a loudspeaker or a microphone in other examples). Similarly, the antennas 24₁, 24₂, 24₃ may be unaffected by the electronic component or components 32. The stacked arrangement 56 may provide an additional advantage of providing a plurality of wireless radio protocols in a compact volume within a single aperture in a conductive cover. By providing only one aperture in an electronic device, the device may be more desirable aesthetically to the end user.

It should be appreciated that there may be more than one radio frequency feed and/or ground connection per antenna 24₁, 24₂, 24₃. Furthermore, the radio frequency feeds and/or ground connections may be coupled to the cover 22 or a PWB and subsequently onto the radio frequency circuitry 14 (for the radio frequency feeds) or the ground member 18 (for the ground connections). For example, the feeds 36₂, 36₃ of the second and third antennas 24₂, 24₃ may be coupled to the conductive cover portion 22, and the feed 36₁ of the first antenna 24₁ may be coupled to another component such as a printed circuit board.

It should also be appreciated that one or more of the antennas 24₁, 24₂, 24₃ in the stacked arrangement 56 may not have the same alignment or orientation as the remaining antennas 24₁, 24₂, 24₃. For example in FIG. 5, the first antenna 24₁ is rotated ninety degrees relative to the second and third antennas 24₂, 24₃. This may advantageously reduce coupling between antennas 24₁, 24₂, 24₃ since the high electric field/magnetic field portions of the antennas 24₁, 24₂, 24₃ may not be adjacent one another to cause high coupling regions. This may improve isolation between adjacent antennas 24₁, 24₂, 24₃.

It should also be appreciated that one or more of the antennas 24₁, 24₂, 24₃ in the stacked arrangement 56 may not be disposed in a planar or two dimensional manner, but instead may comprise one or more portions which are bent or curved to provide an antenna which is three dimensional and physically located in more than one plane. This may advantageously provide portions of the one or more antenna which couple at radio frequencies to an adjacent radiator or antenna and/or the ground plane so that additional capacitance is built in to the antenna for tuning the antenna resonance to different frequency bands.

In some examples, one or more of the antennas 24₁, 24₂, 24₃ may be a multi-turn radio frequency identification (RFID) coil (not illustrated).

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the applicant claims protection in respect of any patentable feature or combination of features hereinbefore referred to and/or shown in the drawings whether or not particular emphasis has been placed thereon.

I/we claim:

1. An apparatus comprising:
a ground member;
a conductive cover portion defining a first non-conductive aperture and grounded to the ground member; and
an antenna configured to couple to radio frequency circuitry, the antenna being positioned at least in part within the periphery of the first non-conductive aperture.

2. The apparatus as claimed in claim 1, wherein the first non-conductive aperture is configured to enable a non-antenna related function in addition to having at least a part of the antenna positioned therein.

3. The apparatus as claimed in claim 1, wherein the first non-conductive aperture is configured to receive at least a part of a camera module therein.

4. The apparatus as claimed in claim 3, wherein the first non-conductive aperture is configured to receive a dielectric member therein adjacent the camera module.

5. The apparatus as claimed in claim 1, wherein the antenna defines a second non-conductive aperture configured to receive at least a part of a camera module therein.

6. The apparatus as claimed in claim 1, wherein the antenna provides a cover portion of the apparatus.

7. The apparatus as claimed in claim 1, wherein the antenna has a first end and a second end, the antenna being coupled to a feed point between the first end and the second end, and grounded at the second end.

8. The apparatus as claimed in claim 6, wherein the first end of the antenna is electrically open.

9. The apparatus as claimed in claim 1, wherein the conductive cover portion comprises a ground point, the antenna being coupled to the ground point.

10. The apparatus as claimed in claim 1, wherein the conductive cover portion comprises a feed point configured to couple to the radio frequency circuitry, the antenna being coupled to the feed point.

11. The apparatus as claimed in claim 1, further comprising one or more further antennas having a stacked arrangement with the antenna, the one or more further antennas being positioned at least in part within the periphery of the first non-conductive aperture.

12. The apparatus as claimed in claim 1, further comprising a camera module, the antenna being unattached to the camera module.

13. A portable electronic device comprising an apparatus as claimed in claim 1.

14. A method of manufacturing an apparatus, the method comprising:
providing a ground member;
providing a conductive cover portion defining a first non-conductive aperture and grounded to the ground member; and
providing an antenna configured to couple to radio frequency circuitry, the antenna being positioned at least in part within the periphery of the first non-conductive aperture.

15. The method as claimed in claim 14, wherein the first non-conductive aperture is configured to enable a non-antenna related function in addition to having at least a part of the antenna positioned therein.

16. The method as claimed in claim 14, wherein the first non-conductive aperture is configured to receive at least a part of a camera module therein.

17. The method as claimed in claim 14, wherein the antenna defines a second non-conductive aperture configured to receive at least a part of a camera module therein.

18. The method as claimed in claim 14, wherein the antenna provides a cover portion of the apparatus.

19. The method as claimed in claim 14, wherein the antenna has a first end and a second end, the antenna being coupled to a feed point between the first end and the second end, and grounded at the second end.

20. The method as claimed in claim 14, wherein the conductive cover portion comprises a ground point, the antenna being coupled to the ground point.
